(19) United States
(12) Patent Application Publication
(10) Pub. No.: US 2023/0364798 A1
(43) Pub. Date: Nov. 16, 2023

(54) INFORMATION PROCESSING METHOD, IMAGE PROCESSING METHOD, ROBOT CONTROL METHOD, PRODUCT MANUFACTURING METHOD, INFORMATION PROCESSING APPARATUS, IMAGE PROCESSING APPARATUS, ROBOT SYSTEM, AND RECORDING MEDIUM

(71) Applicant: CANON KABUSHIKI KAISHA, Tokyo (JP)

(72) Inventors: AKIHIRO ODA, Kanagawa (JP); TAISHI MATSUMOTO, Kanagawa (JP); YUICHIRO KUDO, Kanagawa (JP)

(21) Appl. No.: 18/314,714

(22) Filed: May 9, 2023

(30) Foreign Application Priority Data
May 12, 2022 (JP) 2022-079058
Apr. 6, 2023 (JP) 2023-061803

(51) Int. Cl. B25J 9/16; G06T 7/70; G05B 13/02; G05B 19/4155

(52) U.S. Cl. CPC B25J 9/1697; B25J 9/163; G05B 13/0265; G05B 19/4155; G06T 7/70; G05B 2219/50391; G06T 2207/20081; G06T 2207/30164; G06T 2207/30242

(57) ABSTRACT

An information processing method for obtaining a learned model configured to output information of a workpiece includes obtaining first image data and second image data. The first image data includes an image corresponding to a first number of workpieces disposed in a container or to the first number of virtual workpieces disposed in a virtual container. The second image data includes an image corresponding to a second number of workpieces disposed in the container or to the second number of virtual workpieces disposed in the virtual container. The second number is different from the first number. The information processing method includes obtaining the learned model by machine learning using the first image data and the second image data as input data.

### BACKGROUND

### Field of the Disclosure

The present disclosure relates to a technique of obtaining information of a workpiece.

### Description of the Related Art

Japanese Patent Laid-Open No. 2020-082322 discloses a robot system that performs a picking work. The picking work is a work in which a robot picks up a workpiece from workpieces randomly piled up on a tray or a flat plate instead of being placed at predetermined positions. Japanese Patent Laid-Open No. 2020-082322 discloses generating a learned model by machine learning by using, as teacher data, a data set including image data obtained by imaging a virtual workpiece and coordinates data of a virtual robot hand of a case where the virtual robot hand successfully grips the virtual workpiece. The learned model generated by machine learning is stored in a storage device. At the time of the picking work, by using the learned model, the coordinates data of a robot hand is obtained from image data obtained by imaging the workpieces that are randomly piled up, and the robot is controlled on the basis of the coordinates data.

### SUMMARY

According to a first aspect of the present disclosure, an information processing method for obtaining a learned model configured to output information of a workpiece includes obtaining first image data and second image data. The first image data includes an image corresponding to a first number of workpieces disposed in a container or to the first number of virtual workpieces disposed in a virtual container. The second image data includes an image corresponding to a second number of workpieces disposed in the container or to the second number of virtual workpieces disposed in the virtual container. The second number is different from the first number. The information processing method includes obtaining the learned model by machine learning using the first image data and the second image data as input data.

According to a second aspect of the present disclosure, an image processing method for obtaining a learned model configured to output information of a workpiece includes obtaining first image data and second image data. The first image data includes an image corresponding to a first number of workpieces disposed in a container or to the first number of virtual workpieces disposed in a virtual container. The second image data includes an image corresponding to a second number of workpieces disposed in the container or to the second number of virtual workpieces disposed in the virtual container. The second number is different from the first number. The image processing method includes obtaining the learned model by machine learning using the first image data and the second image data as input data.

According to a third aspect of the present disclosure, an information processing apparatus includes a processor configured to obtain a learned model configured to output information of a workpiece. The processor obtains first image data and second image data. The first image data includes an image corresponding to a first number of workpieces disposed in a container or to the first number of virtual workpieces disposed in a virtual container. The second image data includes an image corresponding to a second number of workpieces disposed in the container or to the second number of virtual workpieces disposed in the virtual container. The second number is different from the first number. The processor obtains obtains the learned model by machine learning using the first image data and the second image data as input data.

According to a fourth aspect of the present disclosure, an image processing apparatus includes a processor configured to obtain a learned model configured to output information of a workpiece. The processor obtains first image data and second image data. The first image data includes an image corresponding to a first number of workpieces disposed in a container or to the first number of virtual workpieces disposed in a virtual container. The second image data includes an image corresponding to a second number of workpieces disposed in the container or to the second number of virtual workpieces disposed in the virtual container. The second number is different from the first number. The processor obtains the learned model by machine learning using the first image data and the second image data as input data.

Further features of the present disclosure will become apparent from the following description of exemplary embodiments with reference to the attached drawings.

### BRIEF DESCRIPTION OF THE DRAWINGS

FIG. 1 is an explanatory diagram illustrating a schematic configuration of a robot system according to a first embodiment.

FIG. 2 is an explanatory diagram of an image processing apparatus according to a first embodiment.

FIG. 3 is a block diagram of a computer system in a robot system according to the first embodiment.

FIG. 4 is a functional block diagram of a processor according to the first embodiment.

FIG. 5 is a flowchart of an information processing method according to the first embodiment.

FIG. 6 is an explanatory diagram of a data set according to the first embodiment.

FIG. 7A is an explanatory diagram of a state in which the packing ratio of workpieces according to the first embodiment is low.

FIG. 7B is an explanatory diagram of a state in which the packing ratio of the workpieces according to the first embodiment is high.

FIG. 8A is an explanatory diagram of a state in which the workpieces according to the first embodiment are randomly piled up in a container.

FIG. 8B is an explanatory diagram of a state in which the workpieces according to the first embodiment are randomly piled up in a container.

FIG. 8C is an explanatory diagram of a state in which the workpieces according to the first embodiment are randomly piled up in a container.

FIG. 9 is a graph indicating a correlation between the number of data sets and a correct answer rate according to the first embodiment.

FIG. 10A is a diagram for describing an effect according to the first embodiment.

FIG. 10B is a diagram for describing an effect according to the first embodiment.

FIG. 11A is a schematic diagram for describing the distance between a camera and an inner bottom surface of a container according to a second embodiment.

FIG. 11B is a schematic diagram for describing the distance between the camera and the inner bottom surface of the container according to the second embodiment.

FIG. 12 is a functional block diagram of a processor according to a third embodiment.

FIG. 13A is an explanatory diagram of a state in which virtual workpieces according to a third embodiment are randomly piled up in a virtual container.

FIG. 13B is an explanatory diagram of a state in which the virtual workpieces according to the third embodiment are randomly piled up in the virtual container.

FIG. 13C is an explanatory diagram of a state in which the virtual workpieces according to the third embodiment are randomly piled up in the virtual container.

FIG. 14A is an explanatory diagram of a state in which the virtual workpieces according to the third embodiment are randomly piled up in the virtual container.

FIG. 14B is an explanatory diagram of a state in which the virtual workpieces according to the third embodiment are randomly piled up in the virtual container.

FIG. 15 is an explanatory diagram of free-fall simulation according to the third embodiment.

FIG. 16 is an explanatory diagram of a user interface image according to a fourth embodiment.

### DESCRIPTION OF THE EMBODIMENTS

In image data obtained at the time of a picking work by imaging workpieces that are randomly piled up, how the workpiece appears varies greatly in accordance with the situation. Therefore, stably obtaining information of the workpiece in accordance with the situation is desired.

In the present disclosure, information of a workpiece is stably obtained in accordance with the situation.

Exemplary embodiments of the present disclosure will be described in detail below with reference to drawings.

### First Embodiment

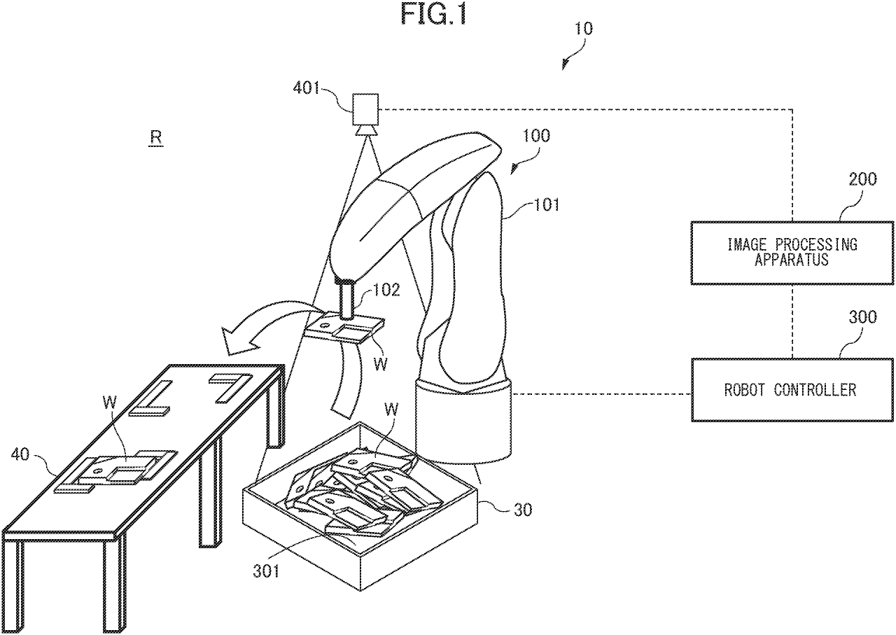

FIG. 1 is an explanatory diagram illustrating a schematic configuration of a robot system 10 according to a first embodiment. The robot system 10 includes a robot 100, an image processing apparatus 200 serving as an example of an information processing apparatus, a robot controller 300, and a camera 401 serving as an example of an image pickup apparatus. The robot 100 is an industrial robot, is disposed in a manufacturing line, and is used for manufacturing a product.

The robot 100 is a manipulator. For example, the robot 100 is fixed to a stand. A container 30 opening upward and a placement table 40 are disposed near the robot 100. A plurality of workpieces W are randomly piled up in the container 30. That is, the plurality of workpieces W are randomly piled up on an inner bottom surface 301 of the container 30. The workpieces W are each an example of a holding target, and is, for example, a part. The plurality of workpieces W in the container 30 are held and conveyed one by one by the robot 100 and to a predetermined position on the placement table 40. The plurality of workpieces W each have the same shape, the same size, and the same color. The workpiece W is, for example, a member having a flat plate shape, and the shape thereof is different between the front surface and the back surface thereof.

The robot 100, the camera 401, the container 30, the placement table 40, the workpieces W, and the like are disposed in a real space R.

The robot 100 and the robot controller 300 are communicably connected to each other via wiring. The robot controller 300 and the image processing apparatus 200 are communicably connected to each other via wiring. The camera 401 and the image processing apparatus 200 are communicably connected to each other via wired connection or wireless connection.

The robot 100 includes a robot arm 101, and a robot hand 102 that is an example of an end effector, that is, a holding mechanism. The robot arm 101 is a vertically articulated robot arm. The robot hand 102 is supported by the robot arm 101. The robot hand 102 is attached to a predetermined portion of the robot arm 101, for example, a distal end portion of the robot arm 101. The robot hand 102 is configured to be capable of holding the workpiece W. To be noted, although a case where the holding mechanism is the robot hand 102 will be described, the configuration is not limited to this, and for example, the holding mechanism may be a suction pad mechanism capable of holding a workpiece by vacuum suction, or an air suction mechanism capable of holding a workpiece by sucking air.

According to the configuration described above, the robot 100 can perform a desired work by moving the robot hand 102 to a desired position by the robot arm 101. For example, by preparing a workpiece W and another workpiece and causing the robot 100 to perform a work of coupling the workpiece W to the other workpiece, an assembled workpiece can be manufactured as a product. As described above, a product can be manufactured by the robot 100. To be noted, although a case of manufacturing a product by assembling workpieces by the robot 100 has been described as an example in the first embodiment, the configuration is not limited to this. For example, the robot arm 101 may be provided with a tool such as a cutting tool or a polishing tool, and the product may be manufactured by processing a workpiece by the tool.

The camera 401 is a digital camera, and includes an unillustrated image sensor. The image sensor is, for example, a complementary metal oxide semiconductor: CMOS image sensor, or a charge-coupled device: CCD image sensor. The camera 401 is fixed to an unillustrated frame disposed near the robot 100. The camera 401 is disposed at such a position that the camera 401 is capable of imaging a region including the plurality of workpieces W disposed in the container 30. That is, the camera 401 is capable of imaging the region including the workpieces W serving as holding targets of the robot 100. For example, the camera 401 is disposed above the robot 100 so as to image vertically downward.

The image processing apparatus 200 is constituted by a computer in the first embodiment. The image processing apparatus 200 is capable of transmitting an image pickup command to the camera 401 to cause the camera 401 to perform imaging. The image processing apparatus 200 is configured to be capable of obtaining image data generated by the camera 401, and is configured to be capable of processing the obtained image data.

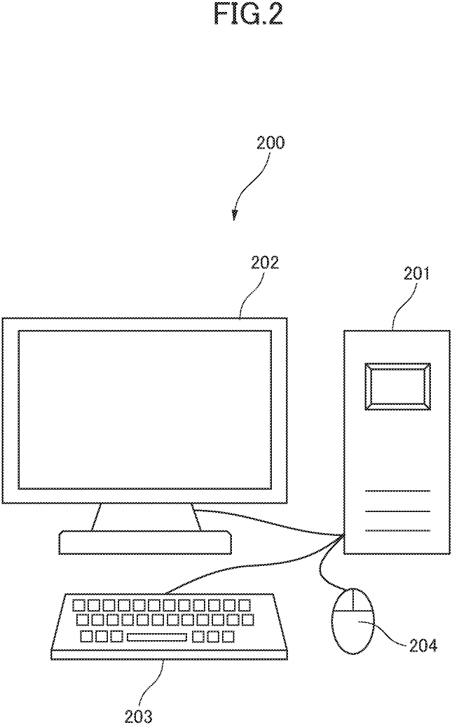

FIG. 2 is an explanatory diagram of the image processing apparatus 200 according to the first embodiment. The image processing apparatus 200 includes a body 201, a display 202 that is an example of a display portion, and a keyboard 203 and a mouse 204 that are examples of an input device. The display 202, the keyboard 203, and the mouse 204 are connected to the body 201.

The robot controller 300 illustrated in FIG. 1 is constituted by a computer in the first embodiment. The robot controller 300 is configured to be capable of controlling the operation of the robot 100, that is, the posture of the robot 100.

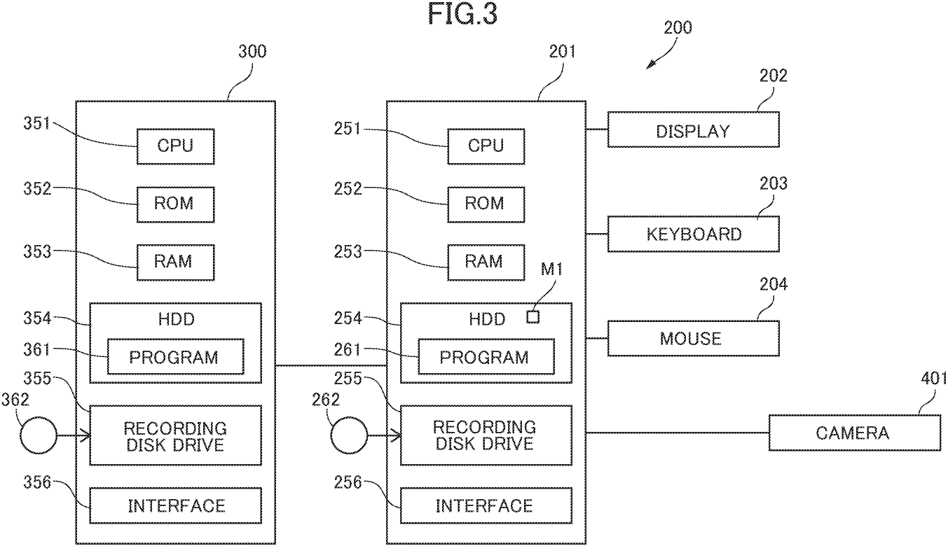

FIG. 3 is a block diagram of a computer system in the robot system 10 according to the first embodiment. The body 201 of the image processing apparatus 200 includes a central processing unit: CPU 251 that is an example of a processor. The CPU 251 functions as a processor by executing a program 261. In addition, the body 201 includes a read-only memory: ROM 252, a random access memory: RAM 253, and a hard disk drive: HDD 254 as storage portions. In addition, the body 201 includes a recording disk drive 255, and an interface 256 that is an input/output interface. The CPU 251, the ROM 252, the RAM 253, the HDD 254, the recording disk drive 255, and the interface 256 are mutually communicably interconnected by a bus.

The interface 256 of the body 201 is connected to the robot controller 300, the display 202, the keyboard 203, the mouse 204, and the camera 401.

The ROM 252 stores a basic program related to the operation of the computer. The RAM 253 is a storage device that temporarily stores various data such as arithmetic processing results of the CPU 251. The HDD 254 stores arithmetic processing results of the CPU 251, various data obtained from the outside, and the like, and stores a program 261 for causing the CPU 251 to execute various processes. The program 261 is application software that can be executed by the CPU 251.

The CPU 251 executes the program 261 stored in the HDD 254, and is thus capable of executing image processing and machine learning processing that will be described later. In addition, the CPU 251 executes the program 261, and is thus capable of controlling the camera 401 and obtaining image data from the camera 401. The recording disk drive 255 can read out various data, programs, and the like stored in a recording disk 262.

To be noted, although the HDD 254 is a non-transitory computer-readable recording medium and stores the program 261 in the first embodiment, the configuration is not limited to this. The program 261 may be stored in any recording medium as long as the recording medium is a non-transitory computer-readable recording medium. Examples of the recording medium for supplying the program 261 to the computer include flexible disks, hard disks, optical disks, magneto-photo disks, magnetic tapes, and nonvolatile memories.

The robot controller 300 includes a CPU 351 that is an example of a processor. The CPU 351 functions as a controller by executing a program 361. In addition, the robot controller 300 includes a ROM 352, a RAM 353, and an HDD 354 as storage portions. In addition, the robot controller 300 includes a recording disk drive 355, and an interface 356 that is an input/output interface. The CPU 351, the ROM 352, the RAM 353, the HDD 354, the recording disk drive 355, and the interface 356 are mutually communicably interconnected by a bus.

The ROM 352 stores a basic program related to the operation of the computer. The RAM 353 is a storage device that temporarily stores various data such as arithmetic processing results of the CPU 351. The HDD 354 stores arithmetic processing results of the CPU 351, various data obtained from the outside, and the like, and stores a program 361 for causing the CPU 351 to execute various processes. The program 361 is application software that can be executed by the CPU 351.

The CPU 351 executes the program 361 stored in the HDD 354, and is thus capable of executing control processing to control the operation of the robot 100 of FIG. 1. The recording disk drive 355 is capable of loading various data, programs, and the like stored in the recording disk 362.

To be noted, although the HDD 354 is a non-transitory computer-readable recording medium and stores the program 361 in the first embodiment, the configuration is not limited to this. The program 361 may be stored in any recording medium as long as the recording medium is a non-transitory computer-readable recording medium. Examples of the recording medium for supplying the program 361 to the computer include flexible disks, hard disks, optical disks, magneto-photo disks, magnetic tapes, nonvolatile memories, and the like.

To be noted, although the functions of a processor that executes image processing and machine learning processing and a controller that executes control processing are realized by a plurality of computers, that is, the plurality of CPUs 251 and 351 in the first embodiment, the configuration is not limited to this. The functions of the processor that executes the image processing and machine learning processing, and the functions of the controller that executes the control processing may be realized by one computer, that is, one CPU.

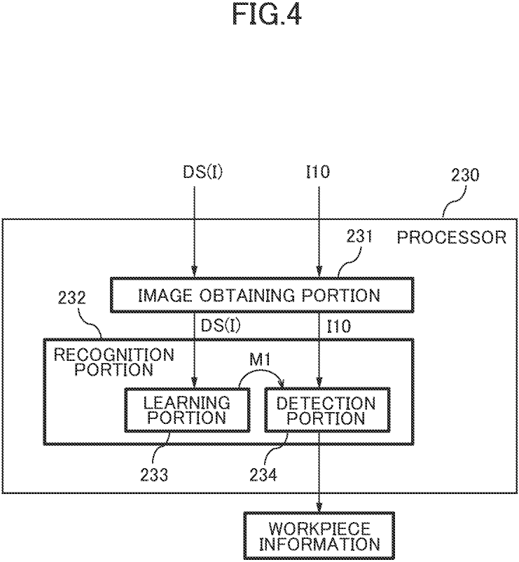

FIG. 4 is a functional block diagram of a processor 230 according to the first embodiment. The CPU 251 of the image processing apparatus 200 executes the program 261, and thus functions as the processor 230. The processor 230 includes an image obtaining portion 231 and a recognition portion 232. The recognition portion 232 includes a learning portion 233 and a detection portion 234. The recognition portion 232 is capable of selectively executing a learning mode and a detection mode. The recognition portion 232 functions the learning portion 233 in the learning mode, and functions the detection portion 234 in the detection mode.

The image obtaining portion 231 has a function of, in both the learning mode and the detection mode, causing the camera 401 to image the region where the workpieces W are present and obtaining image data from the camera 401.

Here, the image data obtained in the learning mode will be referred to as image data I. In addition, the image data obtained in the detection mode will be referred to as captured image data I10 to distinguish the captured image data I10 from the image data I obtained in the learning mode.

The learning portion 233 generates a learned model M1 used in the detection portion 234. The learned model M1 is a learned model using the captured image data I10 as input data and information of the workpieces W as output data. The detection portion 234 has a function of detecting information of the position of and the information of the posture of the workpiece W serving as a holding target by using the learned model M1, on the basis of the captured image data I10 obtained by the image obtaining portion 231.

As the learning algorithm used in the recognition portion 232, algorithms such as single shot multibox detector: SSD and you look only once: YOLO that are kinds of machine learning can be used, but different algorithm may be used as long as the different algorithm has a similar function.

First, the detection portion 234 will be described. The detection portion 234 has a function of loading the learned model M1 generated by the learning portion 233 from, for example, a storage device such as the HDD 254, and detecting information of the workpieces W from the captured image data I10 obtained by imaging the workpieces W, on the basis of the learned model M1. The information of the workpieces includes information of the positions and orientations of the workpieces W. The information of the orientations of the workpieces W include information about which of the front surface and the back surface of the workpieces W faces upward.

The information of the positions and orientations of the workpieces W is transmitted to the robot controller 300. The CPU 351 of the robot controller 300 controls the robot 100 on the basis of the obtained information of the positions and orientations of the workpieces W, and is thus capable of holding a workpiece W serving as a holding target and moving the workpiece onto the placement table 40.

Next, the learning portion 233 will be described. Examples of the machine learning include “supervised learning” in which learning is performed by using teacher data, which is a data set of input data and output data, “unsupervised learning” in which learning is performed by using only input data, and “reinforcement learning” in which learning is processed by using a policy and a reward starting from the output data. Among these, “supervised learning” is suitable for detecting workpieces that are randomly piled up because the learning can be efficiently performed if a data set is prepared. The learning portion 233 may perform any one of unsupervised learning, supervised learning, and reinforcement learning, but supervised learning is performed in the first embodiment. A learning method using SSD as an example of an algorithm for detecting the information of the positions and orientations of the workpieces W from image data will be described.

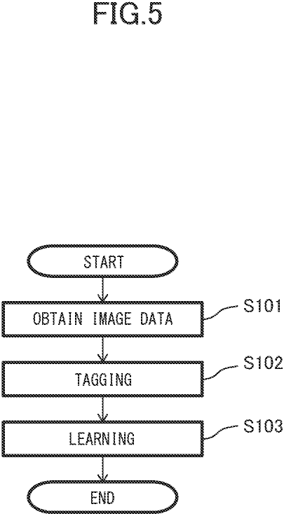

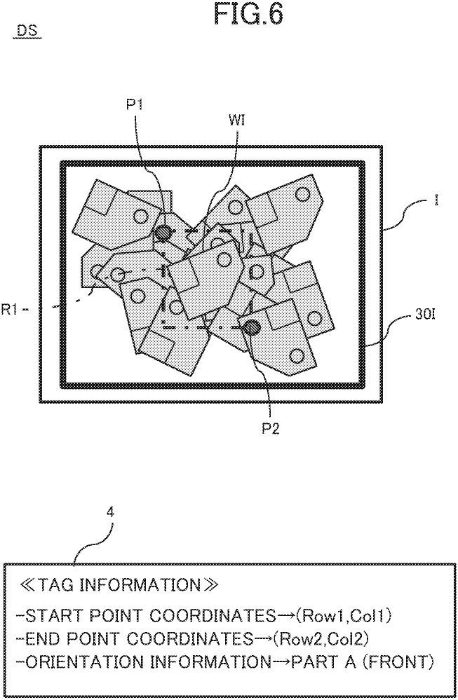

FIG. 5 is a flowchart of an information processing method, that is, an image processing method according to the first embodiment. First, in step S101, the learning portion 233 obtains the image data I from the image obtaining portion 231. The image data I obtained from the image obtaining portion 231 is a tone image as illustrated in FIG. 6. FIG. 6 is an explanatory diagram of a data set DS. The image data I includes workpiece images WI corresponding to the workpieces W, and a container image 30I corresponding to the container 30.

Next, in step S102, the learning portion 233 performs a tagging operation of associating the image data I with tag information 4 illustrated in FIG. 6. The tag information 4 is information of the workpieces W. The tagging operation is performed by the learning portion 233 in accordance with an instruction from a user.

For example, the learning portion 233 displays the image data I as an image on the display 202, and receives input of the tag information 4 to be associated with the image data I. The tag information 4 includes information of the position of a workpiece W and information of the orientation of the workpiece W.

In the first embodiment, as the information of the position of the workpiece W, input of start point coordinates P1 and end point coordinates P2 in the image data I is received. The start point coordinates P1 and the end point coordinates P2 are coordinates of diagonally opposite corners of a rectangular region R1, and are set such that a workpiece image WI corresponding to the workpiece W is included in the rectangular region R1. In addition, in the first embodiment, input of information about which of the front surface and the back surface of the workpieces W faces upward is received as information of the orientations of the workpieces W. To be noted, the information of the workpiece W associated with the image data I is not limited to the examples described above. For example, the information of the workpiece W may include more detailed numerical value expressions.

The tag information 4 can be added to a workpiece image WI corresponding to a workpiece W that is in the image data I and that can be picked up, and can be added to, for example, a workpiece image WI whose entire outline is in the image, or a workpiece image WI whose outline is partially blocked from the sight.

By performing the operation of steps S101 and S102, one data set DS for machine learning by the learning portion 233 can be generated. Further, by repeating steps S101 and S102 while changing the randomly piled-up state of the workpieces W, a plurality of data sets DS can be generated.

Next, in step S103, the learning portion 233 performs learning by using the plurality of data sets DS. That is, the learning portion 233 performs learning so as to associate an image feature of the tagged region with the tag information, and thus generates the learned model M1. The learned model M1 generated in this manner is loaded by the detection portion 234. The detection portion 234 can detect the information of the position and orientation of a workpiece W in the captured image data I10 that have been obtained, on the basis of the learned model M1.

In the case of obtaining the information of the workpiece W serving as a holding target by using the learned model M1, the accuracy of the obtained information of the workpiece W depends on the content of the data sets DS used for the learning. For example, in the case where the color of the workpiece image WI corresponding to the workpiece W in the image data I is different between at the time of learning and at the time of detection, there is a possibility that the information of the workpiece W cannot be accurately obtained at the time of detection. In addition, the environment around the workpiece W serving as a holding target varies greatly. The environment around the workpiece W serving as a holding target varying greatly means that how the outline of the workpiece image WI corresponding to the workpiece W serving as a holding target in the captured image data I10 varies greatly when the plurality of workpieces are in a randomly piled-up state. That is, how the outline of the workpiece image WI corresponding to the workpiece W serving as a holding target differs between a state in which the packing ratio of the plurality of workpieces W that are randomly piled up is low and a state in which the packing ratio is high. For example, in a sparse state in which the workpiece W serving as a holding target does not overlap with another workpiece W in the container 30, the color of the edge of the outline of the workpiece image WI corresponding to the workpiece W serving as a holding target is different from the color of the container image 30I. In contrast, in a dense state in which the workpiece W serving as a holding target overlaps with another workpiece W in the container 30, the color of the edge of the workpiece image WI corresponding to the workpiece W serving as a holding target is the same as the workpiece image WI corresponding to the other workpiece . Therefore, to obtain more accurate learning results, the data sets DS used for learning should be diversified as much as possible within a range that can be expected in consideration of actual environments.

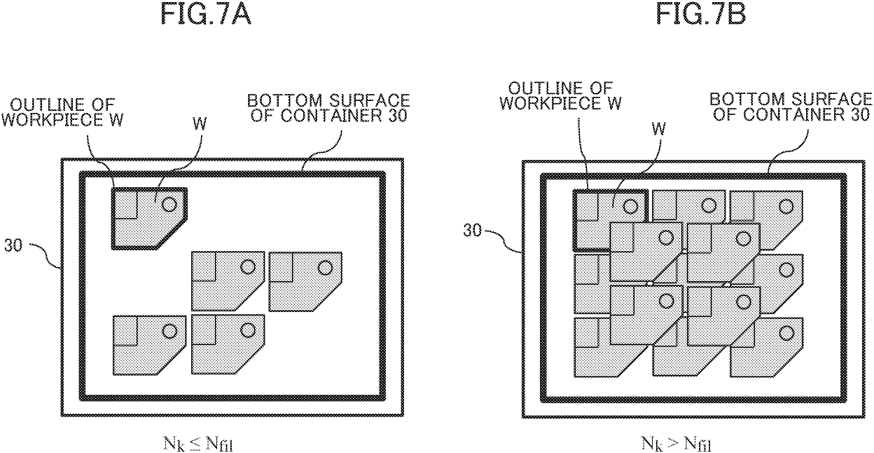

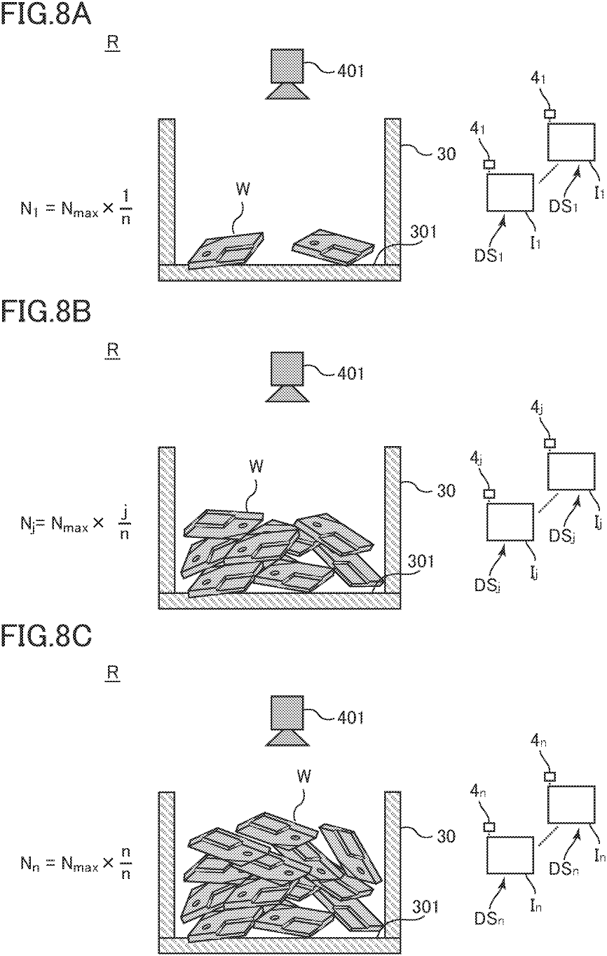

In the first embodiment, an information processing method that generates the learned model M1 with which the workpiece W serving as a holding target can be stably detected even in the case where the number, that is, the packing ratio of the workpieces W that are randomly piled up in the container 30 has changed in the detection mode. FIGS. 7A and 7B are an explanatory diagram for describing high/low of the packing ratio of the workpieces W. FIGS. 8A to 8C are each an explanatory diagram of a state in which the workpieces W according to the first embodiment are randomly piled up in the container 30. FIGS. 8A to 8C each illustrate a schematic diagram in which the workpieces W randomly piled up in the container 30 are viewed in a direction parallel to the ground.

The maximum number of the workpieces W that can be put into the container 30 will be referred to as Nₘₐₓ. In the first embodiment, the maximum number Nₘₐₓ is the number of the workpieces W for filling the container 30 up to the top edge of the container 30, or the number of the workpieces W for filling the container 30 up to a virtual surface slightly lower than the top edge of the container 30. For example, if Nₘₐₓ is 100, the container 30 is filled with 100 of the workpieces W at most. Nₘₐₓ is determined by, for example, the user, that is, the operator.

A division number n for the maximum number Nₘₐₓ is determined. n is an integer larger than 1 and equal to or smaller than Nₘₐₓ, and indicates the number of levels of learning by the learning portion 233. For example, if n is set to 3, the learning is performed for three levels. For example, n is determined by the user, that is, the operator.

The number of the workpieces W put into the container 30 differs depending on the level. For example, the number N₁ of the workpieces W in the first level illustrated in FIG. 8A is represented by the following formula (1).

$${N}_{1} = \left⌊{N}_{m a x} \times \frac{1}{\text{n}}\right⌋ \qquad \text{(1)}$$

To be noted, the formula (1A) represents the maximum integer not exceeding a real number a.

$$\left⌊a\right⌋ \qquad \text{(1A)}$$

The number Nₖ of the workpieces W in the k-th level is represented by the following formula (2).

$${N}_{k} = \left⌊{N}_{m a x} \times \frac{\text{k}}{\text{n}}\right⌋ \left(k = 1 , 2 , ⋯ , n\right) \qquad \text{(2)}$$

When k = n holds, Nₙ = Nₘₐₓ holds.

In the first embodiment, the number of the workpieces W put into the container 30 in each level is determined on the basis of the formula (2). As a result of this, a predetermined number of workpieces W are randomly piled up in the container 30 in each level.

Here, the maximum number of the workpieces W that can be packed, that is, disposed on the inner bottom surface in the container 30 so as to not overlap with each other is represented by N_{fil}. In this case, a state in which Nₖ is equal to or smaller than N_{fil} can be defined as a state in which the packing ratio of the workpieces W is low, which corresponds to a sparse state, and a state in which Nₖ is larger than N_{fil} can be defined as a state in which the packing ratio of the workpieces W is high, which corresponds to a dense state. This will be described with reference to FIGS. 7A and 7B. FIG. 7A illustrates a state in which Nₖ ≤ N_{fil} holds, that is, a state in which the packing ratio of the workpieces W in the container 30 is low. FIG. 7B illustrates a state in which Nₖ > N_{fil} holds, that is, a state in which the packing ratio of the workpieces W in the container 30 is high. In the example of FIGS. 7A and 7B, N_{fil} is set to 9. In the state of FIG. 7A, the number Nₖ of the workpieces W is 5 and thus Nₖ ≤N_{fil} holds, and therefore this state is a sparse state. In the state of FIG. 7B, the number Nₖ of the workpieces W is 13 and thus Nₖ > N_{fil} holds, and therefore this state is a dense state. In this manner, for each level, whether the packing ratio of the workpieces W is high or low can be defined in accordance with the number of the workpieces W. For example, in the case where Nₘₐₓ = 100, n = 3, N_{fil} = 50, N₁ = 33, N₂ = 66, and N₃ = 100 hold, it can be determined that N₁ corresponds to a state in which the packing ratio of the workpieces W is low, and N₂ and N₃ correspond to a state in which the packing ratio of the workpieces W is high.

The reason why the number N_{fil} is used as the determination criterion of whether the packing ratio of the workpieces W is high or low is based on the following. That is, in the sparse state in which the workpiece W serving as a holding target does not overlap with another workpiece W in the container 30 as illustrated in FIG. 7A, boundaries between all the workpieces W serving as holding targets and the inner bottom surface of the container 30 can be regarded as outlines of workpiece images corresponding to the workpieces W serving as holding targets. In contrast, in the dense state in which the workpiece W serving as a holding target overlaps with another workpiece W in the container 30 as illustrated in FIG. 7B, the boundary between at least one of the workpieces W serving as holding targets and the inner bottom surface of the container 30 cannot be regarded as the outline of the workpiece image corresponding to the workpiece W serving as a holding target. By using the number N_{fil} as a determination criterion of whether the packing ratio is high or low as described above, the processing for recognizing the outline of the workpiece W can be clearly varied between the sparse state and the dense state.

The defined number N_{fil} varies depending on the shape of the workpiece W, the shape of the container 30, and the like. The number N_{fil} may be experimentally set by the user by using actual workpieces W and the container 30, or may be set by simulator by using a virtual container and virtual workpieces. In addition, the definition of sparse/dense state described above is preferably described in a user manual of an apparatus or application software capable of implementing the first embodiment. As a result of this, the user can determine whether the workpieces are in the dense state or the sparse state in the workpiece number of each level by referring to the user manual.

Next, for each level, at least one data set DS for learning is generated. When generating the data set DS, a number Nₖ of workpieces W need to be randomly piled up in the k-th level. Further, when imaging the workpieces W by the camera 401, the randomly piled-up state of the workpieces W is changed each time of imaging by the camera 401 by repeatedly putting the workpieces W into or discharging the workpieces W from the container 30, or repeatedly agitating the workpieces W. In this manner, a data set DS corresponding to a relatively sparse state of the workpieces W, and a data set DS corresponding to a relatively dense state of the workpieces W are generated.

Detailed description will be given below. As illustrated in FIG. 8A, the image data I obtained in the first level will be referred to as image data I₁. In addition, the tag information 4 associated with the image data I₁ will be referred to as tag information 4₁. Further, the data set DS including the image data I₁ and the tag information 4₁ will be referred to as a data set DS₁.

In addition, as illustrated in FIG. 8B, the image data I obtained in the j-th level will be referred to as image data Iⱼ. In addition, the tag information 4 associated with the image data Iⱼ will be referred to as tag information 4ⱼ.

Further, the data set DS including the image data Iⱼ and the tag information 4ⱼ will be referred to as a data set DSⱼ. To be noted, j is an integer, and 1 < j < n holds. To be noted, since there is no j in the case of two levels, a case where the learning is performed for three or more levels will be described as an example.

In addition, as illustrated in FIG. 8C, the image data I obtained in the n-th level will be referred to as image data Iₙ. In addition, the tag information 4 associated with the image data Iₙ will be referred to as tag information 4ₙ. Further, the data set DS including the image data Iₙ and the tag information 4ₙ will be referred to as a data set DSₙ.

In FIG. 8A, the image data I₁ is obtained by imaging a state in which the number of the workpieces W is the smallest, that is, a state in which the number of the workpieces W is N₁. In FIG. 8B, the image data Iⱼ is obtained by imaging a state in which the number of the workpieces W is larger than in the state of FIG. 8A and smaller than in the state of FIG. 8C, that is, a state in which the number of the workpieces W is Nⱼ. In FIG. 8C, the image data Iₙ is obtained by imaging a state in which the number of the workpieces W is the largest, that is, a state in which the number of the workpieces W is Nn.

If the image data I₁ is first image data, for example, the image data Iⱼ is second image data. In addition, if the image data Iⱼ is second image data, for example, the image data Iₙ is third image data. In this case, the image data I₁ is image data obtained by imaging the number N₁ of the workpieces W disposed in the container 30. The number N₁ serves as a first number. The image data Iⱼ is image data obtained by imaging the number Nⱼ of the workpieces W disposed in the container 30. The number Nⱼ serves as a second number different from the first number. The image data Iₙ is image data obtained by imaging the number Nₙ of the workpieces W disposed in the container 30. The number Nₙ serves as a third number different from the second number. In the example of the first embodiment, the first number is at least one, and the second number and the third number are each a plural number. That is, in the example of the first embodiment, the second number is larger than the first number, and the third number is larger than the second number.

Each of the image data I₁, Iⱼ, and Iₙ includes a workpiece image WI corresponding to a workpiece W as illustrated in FIG. 6. In addition, each of the image data I₁, Iⱼ, and Iₙ also includes a container image 30I corresponding to the container 30 as illustrated in FIG. 6.

The image obtaining portion 231 may obtain at least one piece of the image data I₁, but preferably obtains a plurality of pieces of the image data I₁. Similarly, the image obtaining portion 231 may obtain at least one piece of the image data Iⱼ, but preferably obtains a plurality of pieces of the image data Iⱼ. Similarly, the image obtaining portion 231 may obtain at least one piece of the image data Iₙ, but preferably obtains a plurality of pieces of the image data Iₙ.

In the first embodiment, the learning portion 233 obtains a plurality of data sets DS₁, ..., a plurality of data sets DSⱼ, ..., and a plurality of data sets DSₙ as the plurality of data sets DS.

To be noted, when obtaining a plurality of pieces of the image data I₁, the positions and orientations of the workpieces W in the container 30 are changed by, for example, agitating the workpieces W in the container 30 as described above. Similarly, when obtaining a plurality of pieces of the image data Iⱼ, the positions and orientations of the workpieces W in the container 30 are changed by, for example, agitating the workpieces W in the container 30 as described above. Similarly, when obtaining a plurality of pieces of the image data Iₙ, the positions and orientations of the workpieces W in the container 30 are changed by, for example, agitating the workpieces W in the container 30 as described above.

As described above, the learning portion 233 obtains each of the image data I₁, ..., Iₙ generated by the camera 401 on the basis of the image pickup operation by the camera 401, from the camera 401 via the image obtaining portion 231. Further, the learning portion 233 obtains the learned model M1 by machine learning using teacher data including the image data I₁, ..., Iₙ as input data and the tag information 4₁, ..., and 4ₙ as output data.

Here, the number of data sets for each level is preferably a predetermined number. For example, in the case of setting the number of the data sets DS₁ for the first level to 100, the number of the data sets DSⱼ for the j-th level and the number of the data sets DSₙ for the n-th level are each preferably also set to 100.

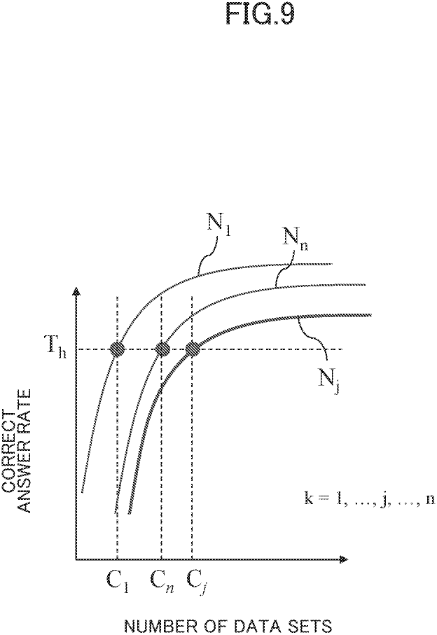

The predetermined number, that is, the number of pieces of image data Iₖ can be determined by, for example, a predetermined algorithm described below. FIG. 9 is a graph illustrating a correlation between the number of data sets and a correct answer rate for each number Nₖ of the workpieces W. The graph of FIG. 9 is obtained by, for example, an experiment. The learned model generated when obtaining the graph illustrated in FIG. 9 by experiment is generated for each level. That is, the learned model for the k-th level is generated by using a data set generated by randomly piling up the number Nₖ of the workpieces W in the container 30. The correct answer rate in the k-th level is a rate of the number of correct answers for the information of the positions and orientations of detected workpieces W to the number of data sets that are a certain number of data sets additionally provided for testing the learned model. Whether or not the answer is correct is determined by the user and input to the learning portion 233 by the user.

The user refers to the graph of FIG. 9 obtained by an experiment, determines a threshold value Tₕ for the correct answer rate, and a number Cₖ of data sets corresponding to the threshold value Tₕ for the number Nₖ of the workpieces W. Then, the user sets, as the predetermined number, the maximum number among the data set number Cₖ of all of k = 1, ...,j, ..., n. In the example of FIG. 9, the data set number Cⱼ is the maximum number, and thus the predetermined number is Cⱼ.

To be noted, the predetermined number may be obtained by an algorithm different from the algorithm using FIG. 9. In addition, although the predetermined number is determined by the user, the configuration is not limited to this, and the predetermined number may be determined by the processor 230, that is, the learning portion 233. In addition, the numbers of the pieces of the image data I₁, ..., Iₙ may be different from each other.

As described above, the image obtaining portion 231 is capable of causing the camera 401 to image the workpieces W put into the container 30 at various packing ratios and obtaining image data I₁, ..., Iₙ thereof. The learning portion 233 is capable of learning the obtained data sets including image data by machine learning, and thus reflecting a wide variety of situations surrounding the workpieces W serving as holding targets on the learned model M1. The learned model M1 generated by the learning portion 233 is loaded by the detection portion 234. The detection portion 234 obtains information of the workpieces W by using the learned model M1, and is thus capable of stably obtaining the information of the workpieces W regardless of the packing ratio of the workpieces W, that is, the number of the workpieces W in the container 30.

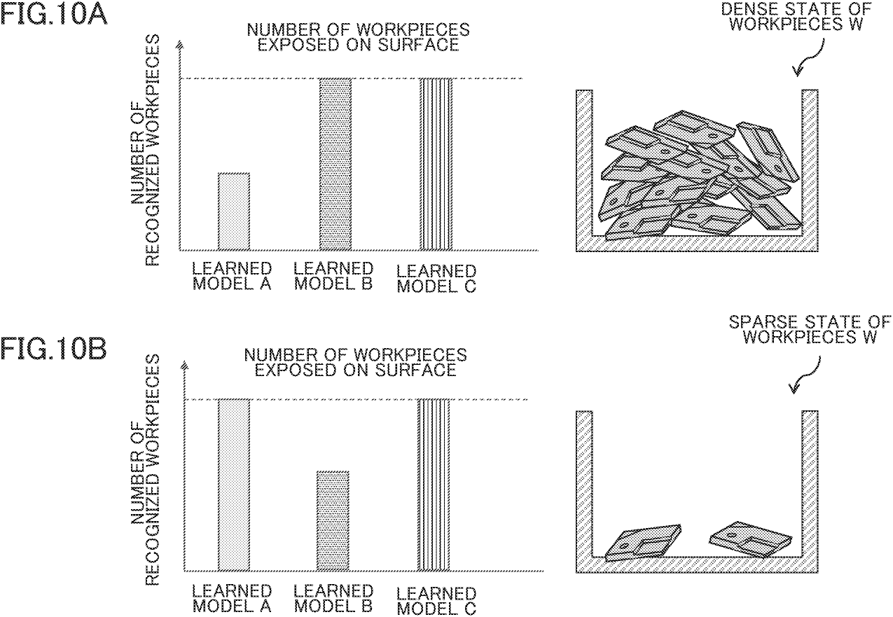

Next, effects of the first embodiment will be described with reference to FIGS. 10A and 10B. FIGS. 10A and 10B illustrate experimental results obtained by causing the detection portion 234 to recognize the workpieces W by using a learned model A having only learned sparse states, a learned model B having only learned dense states, and a learned model C having learned sparse states and dense states in the processing of causing the detection portion 234 to recognize the workpieces W. FIG. 10A illustrates the number of recognized workpieces in the case of causing the detection portion 234 to recognize the workpieces W in a state in which the packing ratio of the workpiece W was high, by respectively using the learned model A having only learned sparse states, the learned model B having only learned dense states, and the learned model C having learned sparse states and dense states. FIG. 10B illustrates the number of recognized workpieces in the case of causing the detection portion 234 to recognize the workpieces W in a state in which the packing ratio of the workpiece W was low, by respectively using the learned model A having only learned sparse states, the learned model B having only learned dense states, and the learned model C having learned sparse states and dense states.

In the experiment, 10 images in which the workpieces W were in a sparse state and 10 images in which the workpieces W were in a dense state were prepared as a predetermined number of images, and for each of the images, the detection portion 234 was caused to execute recognition of the workpieces W by using the three learned models A, B, and C, and an average value of the recognized number was obtained. In addition, for each of an image in which the workpieces W were in a dense state and an image in which the workpieces W were in a sparse state, the number of the workpieces W that the user could recognize as exposed is denoted by “number of workpieces exposed on the surface” in FIGS. 10A and 10B. That is, the number of the workpieces W that should be recognized by the learned models A, B, and C is the “number of workpieces exposed on the surface” indicated in FIGS. 10A and 10B, and this number is used as a base for evaluation of the recognition rate of the workpieces W. In addition, in the graphs illustrated in FIGS. 10A and 10B, the average value of the “number of workpieces exposed on the surface” set for each image is indicated by a dot line, and the average values of the number of workpieces recognized by using the learned models A, B, C, respectively, are indicated by bars. To be noted, in the case of virtually performing an experiment by simulation, when defining the “number of workpieces exposed on the surface”, a predetermined number of reference points, which is at least one, is set on the workpiece W, and perpendicular lines extending upward from the reference points are set. The workpiece W for which a predetermined number of the perpendicular lines do not interfere with another workpiece W may be set as a “workpiece exposed on the surface” for the experiment.

From FIG. 10A, a tendency in which the number of recognized workpieces was smaller than the “number of workpieces exposed on the surface” in the state in which the packing ratio of the workpieces W was high was obtained for the learned model A. For the learned model A, only about 50% to 60% of the “number of workpieces exposed on the surface” was recognized. In contrast, for the learned models B and C, an effect that the number of recognizable workpieces increased as compared with the learned model A was obtained. As illustrated in FIG. 10A, for the learned models B and C, a number of workpieces W approximately equal to the “number of workpieces exposed on the surface” were recognized.

Next, from FIG. 10B, a tendency in which the number of recognized workpieces was smaller than the “number of workpieces exposed on the surface” in the state in which the packing ratio of the workpieces W was low was obtained for the learned model B. For the learned model B, only about 50% to 60% of the “number of workpieces exposed on the surface” was recognized. In contrast, for the learned models A and C, an effect that the number of recognizable workpieces increased as compared with the learned model A was obtained. As illustrated in FIG. 10B, for the learned models B and C, a number of workpieces W approximately equal to the “number of workpieces exposed on the surface” were recognized.

As described above, by using a learning model having learned sparse states and dense states such as the learned model C, the information of workpieces can be stably obtained when picking up workpieces that are randomly piled up. In other words, the acquisition rate of the information of the workpieces, that is, the recognition rate can be improved even in the case where the number of workpieces has changed.

That is, in the picking work, the workpieces W in the container 30 are picked up by the robot 100. Therefore, the number of the workpieces W in the container 30 decreases as the picking work progresses. For example, the number of the workpieces W in the container 30 which is initially Nₙ gradually decreases to Nⱼ, then to N₁, and eventually to 0. How the workpieces W that are randomly piled up appear in the captured image data I10 varies depending on the shadows and reflection of light, and also varies depending on the number of the workpieces W in the container 30. In the first embodiment, machine learning respectively corresponding the numbers N₁, Nⱼ, Nₙ of the workpieces W is performed. Then in the detection mode, the learned model M1 generated by this machine learning is used, and thus the correct answer rate of the information of the workpieces W when detecting the workpieces W is improved even in the case where the number of the workpieces W in the container 30 has changed. Specifically, the correct answer rate of the information of the position and orientation of the workpiece W is improved.

Therefore, the robot 100 can be controlled on the basis of accurate information of the workpieces W, and thus the control of the robot 100 can be stabilized. That is, the robot 100 can be caused to hold the workpiece W at a higher success rate. As a result of this, the success rate of works related to the manufacture can be improved.

### Second Embodiment

In the first embodiment, a method in which a plurality of levels are set for the number of workpieces put into the container 30, a plurality of data sets are prepared for each level, and thus the learning portion 233 performs machine learning has been described.

In the second embodiment, a method in which data sets that vary in the distance between the camera 401 and the inner bottom surface 301 of the container 30 are added to each level and then the learning portion 233 is caused to perform machine learning will be described. To be noted, in the second embodiment, the overall configuration of the robot system 10 is substantially the same as in the first embodiment.

The camera 401 of the second embodiment is configured such that the entirety of the outer shape of the container 30 is within the field of view during the picking work in which the robot 100 picks up the workpieces W that are randomly piled up. For example, as the lens included in the camera 401 of the second embodiment, a lens in which a principal ray has a predetermined field angle with respect to the optical axis, such as a closed circuit television lens: CCTV lens, or a macrosopic lens, is used. In the case of using such a lens, even when the randomly-piled up state of the workpieces W is the same, the sizes of the workpieces W as viewed from the camera 401 change in accordance with the height of the pile of the workpieces W. That is, the sizes of the workpiece images included in the image data change in accordance with the height of the pile of the workpieces W. Such a phenomenon is likely to occur in the case where the distance between the inner bottom surface 301 of the container 30 and the camera 401 varies such as, for example, the case where the thickness of the bottom portion of the container 30 varies for a plurality of containers 30 that are conveyed thereto. In the case where the image data of the case where such a phenomenon occurs is not included in any of the plurality of data sets used for the machine learning, the success rate of detection of the workpieces can deteriorate.

In the second embodiment, for each level, the camera 401 is caused to perform the image pickup operation to obtain a plurality of pieces of image data while vertically moving at least one of the camera 401 and the container 30 to change the distance between the camera 401 and the inner bottom surface 301 of the container 30 within the range in which the camera 401 can maintain the focus. As a result of this, for each level, a plurality of data sets including a plurality of pieces of image data varying in the distance between the camera 401 and the inner bottom surface 301 of the container 30 are generated.

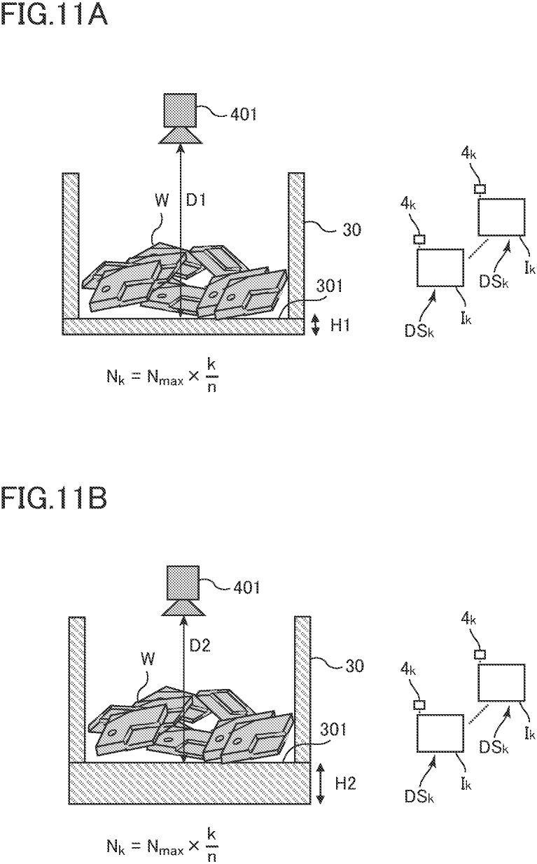

FIGS. 11A and 11B are schematic diagrams for describing the distance between the camera 401 and the inner bottom surface 301 of the container 30 according to the second embodiment. In FIGS. 11A and 11B, k = 1, ..., n holds similarly to the first embodiment.

The thickness of the bottom portion of the container 30 used for the robot system 10 varies. A thickness H1 of the bottom portion of the container 30 illustrated in FIG. 11A is the minimum thickness that is expected, and the distance between the camera 401 and the inner bottom surface 301 of the container 30 in this case is represented by D1. A thickness H2 of the bottom portion of the container 30 illustrated in FIG. 11B is the maximum thickness that is expected, and the distance between the camera 401 and the inner bottom surface 301 of the container 30 in this case is represented by D2. The distance D1 is larger than the distance D2. For the case of a number Nₖ of the workpieces W put into the container 30, the distance between the camera 401 and the inner bottom surface 301 of the container 30 can be changed within a range of (H2 - H1).

In the second embodiment, the number of the workpieces W put into the container 30 is fixed to the number Nₖ, and the camera 401 is caused to perform imaging while changing the distance between the camera 401 and the inner bottom surface 301 of the container 30 within the range from D2 to D1 by changing the thickness of the bottom portion of the container 30 within the range from H1 to H2.

Specifically, data sets are generated while changing the thickness of the bottom portion of the container 30 among a plurality of levels m. In the state in which the number Nₖ of the workpieces W are put into the container 30, a position P_{L} of the inner bottom surface 301 in the L-th level is obtained by the following formula (3).

$${P}_{L} = \text{H1+} \frac{\left(\text{H2} - \text{H1}\right) \times \text{m}}{L} \left(L = 1 , 2 , ⋯ , m\right) \qquad \text{(3)}$$

As described above, at least one data set DSₖ is generated for each of positions P₁ to Pₘ of the inner bottom surface 301 of the container 30 for the number Nₖ of the workpieces W put into the container 30. As a result of this, a plurality of data sets DSₖ are generated. Since k = 1, ..., n holds, a plurality of data sets DS₁, ..., a plurality of data sets DSₙ are generated.

Further, the learning portion 233 performs machine learning by using the plurality of data sets DS₁, ..., plurality of data sets DSₙ, and is thus capable of stably detecting the workpieces W even in the case where the sizes of the workpieces W as viewed from the camera 401 have changed.

To be noted, although a case where the distance between the camera 401 and the inner bottom surface 301 of the container 30 is changed by changing the thickness of the bottom portion of the container 30 has been described as an example, the distance may be changed by a different method. For example, at least one of the container 30 and the camera 401 may be moved in the height direction.

### Third Embodiment

Although a case where the image data I used for generating the data sets DS is obtained from the camera 401 disposed in a real space R has been described in the first embodiment, a case where the image data I is obtained from a virtual camera disposed in a virtual space will be described in the third embodiment. To be noted, in the third embodiment, the overall configuration of the robot system 10 is substantially the same as in the first embodiment.

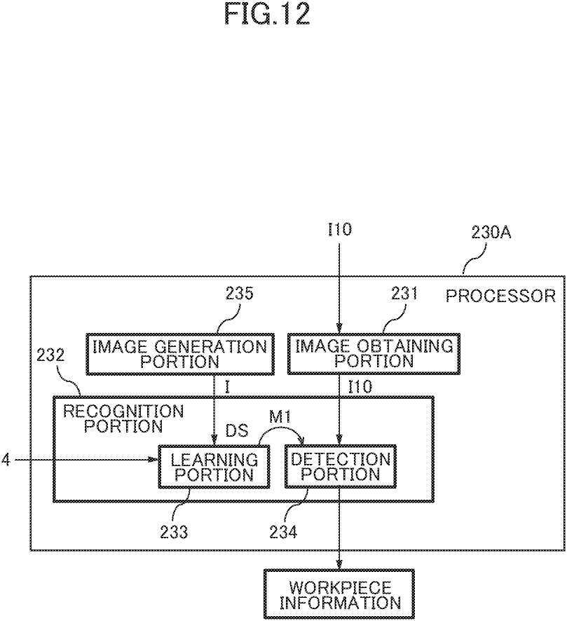

FIG. 12 is a functional block diagram of a processor 230A according to the third embodiment. The CPU 251 of the image processing apparatus 200 illustrated in FIG. 3 executes the program 261, and thus functions as the processor 230A illustrated in FIG. 12. The processor 230A includes the image obtaining portion 231 and the recognition portion 232. The recognition portion 232 includes the learning portion 233 and the detection portion 234. The recognition portion 232 is capable of selectively executing a learning mode and a detection mode similarly to the first embodiment. The recognition portion 232 functions the learning portion 233 in the learning mode, and functions the detection portion 234 in the detection mode.

In addition, the processor 230A includes an image generation portion 235. The image generation portion 235 generates the image data I used for the data sets DS in the learning mode. The learning portion 233 loads the image data I generated by the image generation portion 235 to generate the data sets DS, and generates the learned model M1 by performing machine learning on the basis of the data sets DS. The learned model M1 is loaded by the detection portion 234. The detection portion 231 detects the information of the positions and orientations of the workpieces W in the captured image data I10 obtained from the detection portion 234, on the basis of the learned model M1.

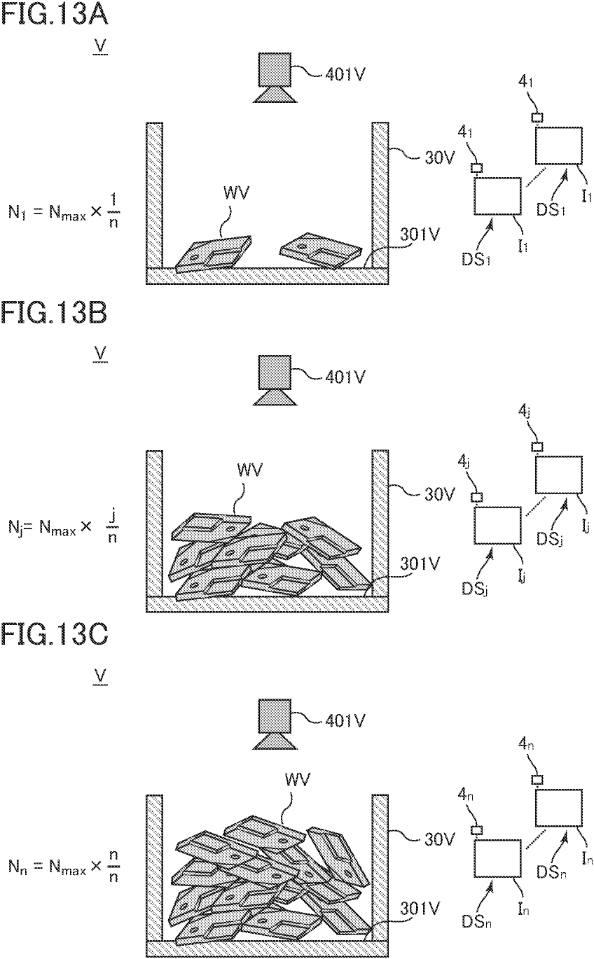

In the third embodiment, an information processing method that generates the learned model M1 with which the workpiece W serving as a holding target can be stably detected even in the case where the number, that is, the packing ratio of the workpieces W that are randomly piled up in the container 30 has changed in the detection mode. FIGS. 13A to 13C are each an explanatory diagram of a state in which virtual workpieces WV according to the third embodiment are randomly piled up in a virtual container 30V FIGS. 13A to 13C each illustrate a schematic diagram in which the virtual workpieces WV randomly piled up in the virtual container 30V are viewed in a direction parallel to a virtual ground.

The image generation portion 235 in the third embodiment has a function of generating a state in which the virtual workpieces WV is randomly piled up in the virtual container 30V in the virtual space V by, for example, physical simulation. To generate such a randomly piled-up state, computer-aided design information: CAD information that is geometrical shape data of the workpieces W and the container 30, the optical characteristics of the camera 401, arrangement information of the camera 401, and the like are input to the image generation portion 235. As a result of this, in the virtual space V, a virtual camera 401V serving as an example of a virtual image pickup apparatus, the virtual container 30V, and the virtual workpieces WV are defined. As a result of this, the image generation portion 235 can generate the image data I including images of the virtual workpieces WV by virtually imaging the virtual workpieces WV that are virtually randomly piled up in the virtual space V by the virtual camera 401V.

The maximum number of the virtual workpieces WV that can be put into the virtual container 30V will be referred to as Nₘₐₓ. In the third embodiment, the maximum number Nₘₐₓ is the number of the virtual workpieces WV for filling the virtual container 30V up to the top edge of the virtual container 30V, or the number of the virtual workpieces WV for filling the virtual container 30V up to a virtual surface slightly lower than the top edge of the virtual container 30V

A division number n for the maximum number Nₘₐₓ is determined. n is an integer larger than 1 and equal to or smaller than Nₘₐₓ, and indicates the number of levels of learning by the learning portion 233. For example, if the n is set to 3, the learning is performed for three levels. For example, n is determined by the user, that is, the operator.

The number of the virtual workpieces WV put into the virtual container 30V differs depending on the level. For example, the number of the virtual workpieces WV in the first level illustrated in FIG. 13A is N₁. The number of the virtual workpieces WV in the j-th level illustrated in FIG. 13B is Nⱼ. The number of the virtual workpieces WV in the n-th level illustrated in FIG. 13C is Nₙ. That is, the number of the virtual workpieces WV in the k-th level is Nₖ.

In the third embodiment, the number of the virtual workpieces WV put into the virtual container 30V in each level is determined on the basis of the formula (2). As a result of this, a predetermined number of workpieces WV are randomly piled up in the virtual container 30V in each level.

In each level, at least one data set DS for learning is generated by the learning portion 233. The learning portion 233 obtains the tag information 4 corresponding to the image data I.

To generate the data sets DS, the number Nₖ of the virtual workpieces WV need to be randomly piled up in the k-th level. Further, when imaging the virtual workpieces WV by the virtual camera 401V, the randomly piled-up state of the virtual workpieces WV is changed each time of imaging by the virtual camera 401V by repeatedly putting the virtual workpieces WV into or discharging the virtual workpieces WV from the virtual container 30V, or repeatedly agitating the virtual workpieces WV, by physical simulation. In this manner, a data set DS corresponding to a relatively sparse state of the virtual workpieces WV, and a data set DS corresponding to a relatively dense state of the virtual workpieces WV are generated.

Detailed description will be given below. As illustrated in FIG. 13A, the image data I obtained in the first level will be referred to as image data I₁. In addition, the tag information 4 associated with the image data I₁ will be referred to as tag information 4₁. Further, the data set DS including the image data I₁ and the tag information 4₁ will be referred to as a data set DS₁.

In addition, as illustrated in FIG. 13B, the image data I obtained in the j-th level will be referred to as image data Iⱼ. In addition, the tag information 4 associated with the image data Iⱼ will be referred to as tag information 4ⱼ. Further, the data set DS including the image data Iⱼ and the tag information 4ⱼ will be referred to as a data set DSⱼ. To be noted, j is an integer, and 1 < j < n holds. To be noted, since there is no j in the case of two levels, a case where the learning has three or more levels will be described as an example.

In addition, as illustrated in FIG. 13C, the image data I obtained in the n-th level will be referred to as image data Iₙ. In addition, the tag information 4 associated with the image data Iₙ will be referred to as tag information 4ₙ. Further, the data set DS including the image data Iₙ and the tag information 4ₙ will be referred to as a data set DSₙ.

In FIG. 13A, the image data I₁ is obtained by imaging a state in which the number of the virtual workpieces WV is the smallest, that is, a state in which the number of the virtual workpieces WV is N₁. In FIG. 13B, the image data Iⱼ is obtained by imaging a state in which the number of the virtual workpieces WV is larger than in the state of FIG. 13A and smaller than in the state of FIG. 13C, that is, a state in which the number of the virtual workpieces WV is Nⱼ. In FIG. 13C, the image data Iₙ is obtained by imaging a state in which the number of the virtual workpieces WV is the largest, that is, a state in which the number of the virtual workpieces WV is Nₙ.

If the image data I₁ is first image data, for example, the image data Iⱼ is second image data. In addition, if the image data Iⱼ is second image data, for example, the image data Iₙ is third image data. In this case, the image data I₁ is image data obtained by imaging the number N₁ of the virtual workpieces WV disposed in the virtual container 30V. The number N₁ serves as a first number. The image data Iⱼ is image data obtained by imaging the number Nⱼ of the virtual workpieces WV disposed in the virtual container 30V The number Nⱼ serves as a second number different from the first number. The image data Iₙ is image data obtained by imaging the number Nₙ of the virtual workpieces WV disposed in the virtual container 30V The number Nₙ serves as a third number different from the second number. In the example of the third embodiment, the first number is at least one, and the second number and the third number are each a plural number. That is, in the example of the third embodiment, the second number is larger than the first number, and the third number is larger than the second number.

Each of the image data I₁, Iⱼ, and Iₙ includes a workpiece image WI corresponding to a virtual workpiece WV as illustrated in FIG. 6. In addition, each of the image data I₁, Iⱼ, and Iₙ also includes a container image 30I corresponding to the virtual container 30V as illustrated in FIG. 6.

The image generation portion 235 may obtain at least one piece of the image data I₁, but preferably obtains a plurality of pieces of the image data I₁. Similarly, the image generation portion 235 may obtain at least one piece of the image data Iⱼ, but preferably obtains a plurality of pieces of the image data Iⱼ. Similarly, the image generation portion 235 may obtain at least one piece of the image data Iₙ, but preferably obtains a plurality of pieces of the image data Iₙ.

In the third embodiment, the learning portion 233 obtains a plurality of data sets DS₁, ..., a plurality of data sets DSⱼ, ..., and a plurality of data sets DSₙ as the plurality of data sets DS.

To be noted, when obtaining a plurality of pieces of the image data I₁, the positions and orientations of the virtual workpieces WV in the virtual container 30V are changed by, for example, performing arithmetic processing of virtually agitating the virtual workpieces WV in the virtual container 30V as described above. Similarly, when obtaining a plurality of pieces of the image data Iⱼ, the positions and orientations of the virtual workpieces WV in the virtual container 30V are changed by, for example, performing arithmetic processing of agitating the virtual workpieces WV in the virtual container 30V as described above. Similarly, when obtaining a plurality of pieces of the image data Iₙ, the positions and orientations of the virtual workpieces WV in the virtual container 30V are changed by, for example, performing arithmetic processing of agitating the virtual workpieces WV in the virtual container 30V as described above.

As described above, the learning portion 233 obtains each of the image data I₁, ..., Iₙ generated by the virtual camera 401V on the basis of the image pickup operation by the virtual camera 401V, from the image generation portion 235. Further, the learning portion 233 obtains the learned model M1 by machine learning using teacher data including the image data I₁, ..., Iₙ as input data and the tag information 4₁, ..., and 4ₙ as output data.

Here, the number of data sets in each level is preferably a predetermined number. For example, in the case of setting the number of the data sets DS₁ for the first level to 100, the number of the data sets DSⱼ for the j-th level and the number of the data sets DSₙ for the n-th level are each preferably also set to 100. The algorithm for determining the predetermined number is, for example, as described in the first embodiment.

As described above, the image generation portion 235 is capable of causing the virtual camera 401V to image the virtual workpieces WV put into the virtual container 30V at various packing ratios and obtaining image data I₁, ..., Iₙ thereof. The learning portion 233 is capable of learning the data sets including the obtained image data by machine learning, and thus reflecting a wide variety of situations of the surroundings of the virtual workpieces WV serving as holding targets on the learned model M1. The learned model M1 generated by the learning portion 233 is loaded by the detection portion 234. The detection portion 234 obtains information of the workpieces W by using the learned model M1, and is thus capable of stably obtaining the information of the workpieces W regardless of the packing ratio of the workpieces W, that is, the number of the workpieces W in the container 30.

That is, in the picking work, the workpieces W in the container 30 are picked up by the robot 100. Therefore, the number of the workpieces W in the container 30 decreases as the picking work progresses. For example, the number of the workpieces in the container 30 which is initially Nₙ gradually decreases to Nⱼ, then to N₁, and eventually to 0. How the workpieces W that are randomly piled up appear in the captured image data I10 varies depending on the shadows and reflection of light, and also varies depending on the number of the workpieces W in the container 30. In the third embodiment, machine learning respectively corresponding the numbers N₁, Nⱼ, Nₙ of the virtual workpieces WV is performed. Then in the detection mode, the learned model M1 generated by this machine learning is used, and thus the correct answer rate of the information of the workpieces W when detecting the workpieces W is improved even in the case where the number of the workpieces W in the container 30 has changed. Specifically, the correct answer rate of the information of the position and orientation of the workpiece W is improved.

Therefore, the robot 100 can be controlled on the basis of accurate information of the workpieces W, and thus the control of the robot 100 can be stabilized. That is, the robot 100 can be caused to hold the workpiece W at a higher success rate. As a result of this, the success rate of works related to the manufacture can be improved.

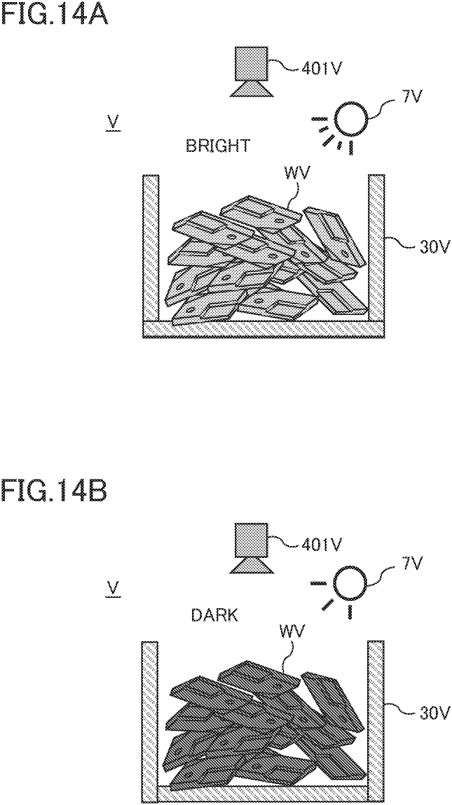

Here, when obtaining the plurality of pieces of image data Iₖ in each level k described above, the lighting conditions may be changed. FIGS. 14A and 14B are explanatory diagrams of the state in which the virtual workpieces WV according to the third embodiment are randomly piled up in the virtual container 30V FIGS. 14A and 14B differ in the lighting conditions. The image generation portion 235 disposes a virtual light source 7V in the virtual space V, and obtains the image data Iₖ while virtually lighting up the virtual light source 7V during the image pickup operation of the virtual camera 401V.

The image generation portion 235 causes the virtual camera 401V to perform imaging while changing the parameters defining the virtual light source 7V and the optical characteristics of the virtual camera 401V within a predetermined range, and thus generates the data sets DS. Examples of the parameters defining the virtual light source 7V include the position, the orientation, the light intensity, and the wavelength.

In the example illustrated in FIGS. 14A and 14B, the image generation portion 235 causes the virtual camera 401V to perform a virtual image pickup operation in a state in which the virtual light source 7V disposed in the virtual space V is lighten up while changing the intensity of the light. As a result of this, the image data I in which the virtual workpieces WV in different appearance are imaged can be obtained.

In addition, examples of the optical characteristics of the virtual camera 401V include lens distortion, blur, shake, and focus. By causing the virtual camera 401V to perform virtual image pickup operation while changing these, the image generation portion 235 can obtain the image data I in which the virtual workpieces WV in different appearance are imaged. Further, the material of the virtual workpieces WV and the virtual container 30V, the spectral characteristics, the color, and the like may be changed, and thus the image generation portion 235 can also obtain the image data I in which the virtual workpieces WV in different appearance are imaged. As described above, by changing various parameters in the virtual space V, the image generation portion 235 can obtain the image data I in which the virtual workpieces WV in different appearance are imaged.

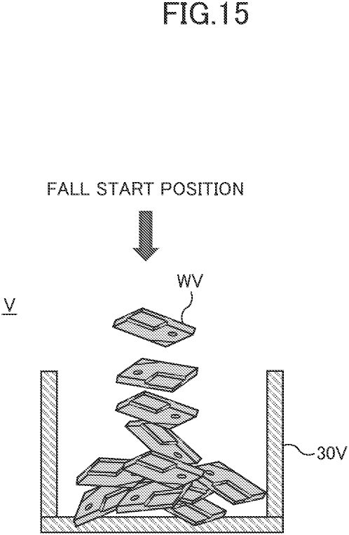

In addition, the image generation portion 235 performs physical simulation in which the virtual workpieces WV free fall from a predetermined height into the virtual container 30V, and thus generates the randomly piled-up state of the virtual workpieces WV. FIG. 15 is an explanatory diagram of the free-fall simulation according to the third embodiment.

In the third embodiment, the image generation portion 235 can generate various randomly piled-up states of the virtual workpieces WV in the virtual space V by changing the fall start position, that is, the height of the free fall of the virtual workpieces WV.

When performing such physical simulation, since the number of the virtual workpieces WV can be also freely changed, the operation of repeatedly adding and discharging the workpieces W or the operation or agitating the workpieces W that is needed for the actual workpieces W is not necessary. Therefore, the data sets DS can be easily generated, and the number of the data sets DS can be also easily increased.

The plurality of data sets DS generated in this manner include the image data I in which the virtual workpieces WV randomly piled up in the virtual container 30V in various states are imaged. The image data I obtained by the physical simulation is image data obtained in consideration of the diversity of the appearance of the virtual workpieces WV, that is, the diversity of the situation around the virtual workpieces WV. The learned model M1 obtained by performing machine learning of the data sets DS is loaded by the detection portion 234. The detection portion 234 is capable of stably detecting the information of the positions and orientations of the workpieces W serving as holding targets even in the case where the number, that is, the packing ratio of the workpieces W in the container 30 has changed in the randomly-piled up state.

To be noted, although a case where the virtual camera 401V is caused to perform imaging while changing the parameters of the virtual light source 7V or the like disposed in the virtual space V has been described, the configuration is not limited to this. The camera 401 may be caused to perform imaging while changing the parameters of an unillustrated light source or the like disposed in the real space.

In addition, in the flowchart illustrated in FIG. 5, although the tagging operation in step S102 may be performed by the user as described above, the tagging operation may be automatically performed by the image generation portion 235. Since the information of the positions and orientations of the virtual workpieces WV in the virtual space V based on the physical simulation is known by the image generation portion 235, the image generation portion 235 can automatically generate the tag information 4. The data sets DS including the image data I and the tag information 4 generated by the image generation portion 235 can be used for machine learning in the learning portion 233.

In addition, also in the third embodiment, the distance between the virtual camera 401V and an inner bottom surface 301V of the virtual container 30V may be changed when obtaining the plurality of pieces of image data Iₖ similarly to the second embodiment.

### Fourth Embodiment

In a fourth embodiment, a user interface image: UI image that graphically displays the series of operations and results described in the third embodiment will be described. To be noted, in the fourth embodiment, the overall configuration of the robot system 10 is substantially the same as in the first embodiment.

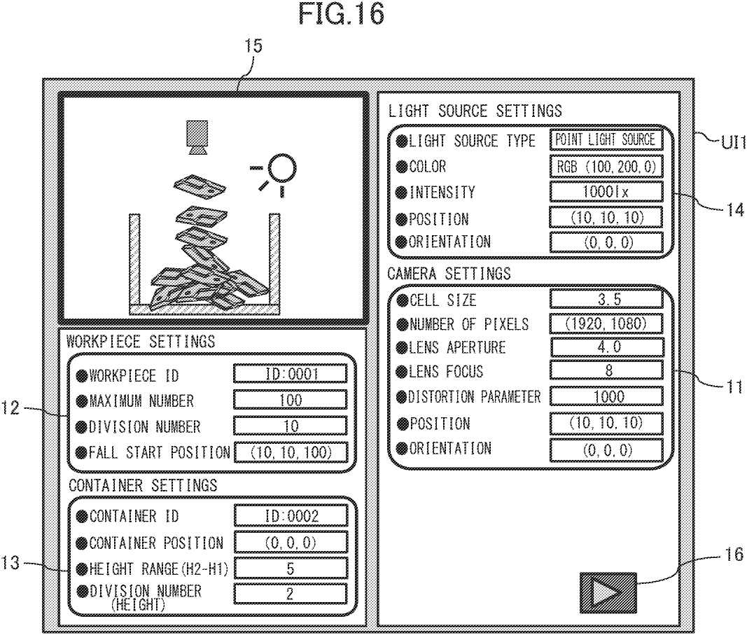

FIG. 16 is an explanatory diagram of a UI image UI₁ according to the fourth embodiment. The UI image UI₁ illustrated in FIG. 16 is displayed on, for example, the display 202 of FIG. 2. The UI image UI₁ includes four input portions 11 to 14, an image display portion 15, and a button 16. The input portion 11 is an example of a first input portion. The input portion 12 is an example of a second input portion. The input portion 13 is an example of a third input portion. The input portion 14 is an example of a fourth input portion.

The image display portion 15 is a screen graphically displaying the state in the virtual container V The user can input various parameters to the input portions 11 to 14 while looking at the image display portion 15.

The input portion 14 includes a plurality of boxes to which setting conditions related to the virtual light source 7V can be input. To the input portion 14, for example, the type of the virtual light source 7V, color information of the light virtually emitted from the virtual light source 7V, information of the intensity of the light virtually emitted from the virtual light source 7V, position information of the virtual light source 7V in the virtual space V, orientation information of the virtual light source 7V in the virtual space V, and the like can be input.

The input portion 11 includes a plurality of boxes to which setting conditions related to the virtual camera 401V can be input. To the input portion 11, for example, information of the cell size, information of the number of pixels, information of the aperture of the virtual lens, information of the focal point of the virtual lens, information of distortion of the virtual lens, information of the position of the virtual camera 401V in the virtual space V, orientation information of the virtual camera 401V in the virtual space V, and the like can be input.

The input portion 12 includes a plurality of boxes to which setting conditions related to the virtual workpieces WV can be input. The input portion 13 includes a plurality of boxes to which setting conditions related to the virtual container 30V can be input.

To the input portion 12, as setting conditions of the virtual workpieces WV in the virtual space V, a workpiece ID indicating the CAD data of the workpiece W, the maximum number of the virtual workpieces WV that can be put into the virtual container 30V, the division number indicating the number of levels, the fall start position where the free falling of the virtual workpieces WV is started, and the like can be input.

To the input portion 13, as the setting conditions of the virtual container 30V in the virtual space V, a container ID indicating the CAD data of the container 30, position information of the virtual container 30V in the virtual space V, the range of (H2 - H1), the division number in the height direction, and the like can be input.

Although examples of the setting conditions that can be input to the input portions 11 to 14 have been described above, the configuration is not limited to this, and the setting conditions that can be input may be added or omitted as appropriate.

The parameters input by the user through the UI image UI₁ are obtained by the image generation portion 235, and are used for physical simulation. That is, the user can cause the image generation portion 235 to establish the various randomly piled-up states of the virtual workpieces WV in the virtual space V by inputting these parameters to the UI image UI₁. Then, the user operates the button 16 to cause the virtual camera 401V in the virtual space V to virtually image the virtual workpieces WV in the randomly piled-up states established in this manner, and thus can cause the image generation portion 235 to generate the image data I.

The information input to the input portions 11 to 14 may be directly input by the user, or automatically input by an unillustrated program. In the case where the information is automatically input by the program, for example, the fall start position of the virtual workpieces WV can be randomly set by using random numbers. In addition, the setting conditions of the virtual light source 7V can be automatically set. In addition, for example, the setting conditions of the virtual light source 7V can be automatically set. As described above, in the case where the information is automatically input, many pieces of the image data I can be obtained in a short time.

As described above, according to the present disclosure, the information of the workpieces can be stably obtained.

The present disclosure is not limited to the embodiments described above, and embodiments can be modified in many ways within the technical concept of the present disclosure. Furthermore, two or more of the various embodiments described above and modification examples thereof may be combined. In addition, the effects described in the embodiments are merely enumeration of the most preferable effects that can be obtained from embodiments of the present disclosure, and effects of embodiments of the present disclosure are not limited to those described in the embodiments.

Although a case where the robot arm 101 is a vertically articulated robot arm has been described, the configuration is not limited to this. For example, various robot arms such as horizontally articulated robot arms, parallel link robot arms, and orthogonal robots may be used as the robot arm 101. In addition, the present disclosure is also applicable to a machine capable of automatically performing extension, contraction, bending, vertical movement, horizontal movement, turning, or a composite operation of these on the basis of information in a storage device provided in a control apparatus.

In addition, although a case where the image pickup apparatus is the camera 401 has been described in the above embodiment, the configuration is not limited to this. The image pickup apparatus may be an electronic device including an image sensor, such as a mobile communication device or a wearable device. Examples of the mobile communication device include smartphones, tablet PCs, and gaming devices.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-079058, filed May 12, 2022, and Japanese Patent Application No. 2023-061803, filed Apr. 6, 2023, which are hereby incorporated by reference herein in their entirety.

What is claimed is:

1. An information processing method for obtaining a leamed model configured to output information of a workpiece, the information processing method comprising:
obtaining first image data and second image data, the first image data including an image corresponding to a first number of workpieces disposed in a container or to the first number of virtual workpieces disposed in a virtual container, the second image data including an image corresponding to a second number of workpieces disposed in the container or to the second number of virtual workpieces disposed in the virtual container, the second number being different from the first number; and
obtaining the learned model by machine learning using the first image data and the second image data as input data.

2. The information processing method according to claim 1, wherein
a plurality of pieces of the first image data and a plurality of pieces of the second image data are obtained, and
the learned model is obtained by machine learning using the plurality of pieces of the first image data and the plurality of pieces of the second image data as the input data.

3. The information processing method according to claim 2, further comprising determining, on a basis of a predetermined algorithm, the number of pieces of the first image data and the number of pieces of the second image data that are to be obtained.

4. The information processing method according to claim 1, wherein the first image data and the second image data each include image data obtained on a basis of an image pickup operation by an image pickup apparatus.

5. The information processing method according to claim 4, wherein a plurality of pieces of the first image data are obtained while changing a distance between the image pickup apparatus and an inner bottom surface of the container.

6. The information processing method according to claim 1, wherein the first image data and the second image data each include image data obtained on a basis of a virtual image pickup operation by a virtual image pickup apparatus.

7. The information processing method according to claim 6, wherein a plurality of pieces of the first image data are obtained while changing a distance between the virtual image pickup apparatus and an inner bottom surface of the virtual container.

8. The information processing method according to claim 6, wherein
the first image data is obtained by performing physical simulation in which the first number of the virtual workpieces are caused to free fall into the virtual container and causing the virtual image pickup apparatus to virtually image the first number of the virtual workpieces randomly piled up in the virtual container, and
the second image data is obtained by performing physical simulation in which the second number of the virtual workpieces are caused to free fall into the virtual container and causing the virtual image pickup apparatus to virtually image the second number of the virtual workpieces randomly piled up in the virtual container.

9. The information processing method according to claim 6, further comprising displaying, on a display portion, a first input portion capable of receiving input of setting conditions of the virtual image pickup apparatus.

10. The information processing method according to claim 6, further comprising displaying, on a display portion, a second input portion capable of receiving input of setting conditions of the virtual workpieces.

11. The information processing method according to claim 6, further comprising displaying, on a display portion, a third input portion capable of receiving input of setting conditions of the virtual container.

12. The information processing method according to claim 6, wherein the first image data is obtained by virtually lighting up a virtual light source in the virtual image pickup operation by the virtual image pickup apparatus.

13. The information processing method according to claim 12, further comprising displaying, on a display portion, a fourth input portion capable of receiving input of setting conditions of the virtual light source.

14. The information processing method according to claim 1, wherein the information of the workpiece includes information of an orientation of the workpiece.

15. The information processing method according to claim 14, wherein the information of the orientation of the workpiece includes information about which of a front surface and a back surface of the workpiece faces upward.

16. The information processing method according to claim 1, wherein the information of the workpiece includes information of a position of the workpiece.

17. The information processing method according to claim 1,
wherein the first number is such a number that a packing ratio of the workpieces in the container or a packing ratio of the virtual workpieces in the virtual container is determined as low, and
wherein the second number is such a number that the packing ratio of the workpieces in the container or the packing ratio of the virtual workpieces in the virtual container is determined as high.

18. The information processing method according to claim 17, wherein whether the packing ratio of the workpieces in the container or the packing ratio of the virtual workpieces in the virtual container is high or low is determined on a basis of a maximum number of the workpieces at which the workpieces are disposed on an inner bottom surface of the container without overlapping with each other, or a maximum number of the virtual workpieces at which the virtual workpieces are disposed on an inner bottom surface of the virtual container without overlapping with each other.

19. An image processing method for obtaining a leamed model configured to output information of a workpiece, the image processing method comprising:
obtaining first image data and second image data, the first image data including an image corresponding to a first number of workpieces disposed in a container or to the first number of virtual workpieces disposed in a virtual container, the second image data including an image corresponding to a second number of workpieces disposed in the container or to the second number of virtual workpieces disposed in the virtual container, the second number being different from the first number; and
obtaining the learned model by machine learning using the first image data and the second image data as input data.

20. A robot control method comprising:
obtaining information of a workpiece from captured image data obtained by imaging the workpiece, the information of the workpiece being obtained by using the learned model obtained by the information processing method according to claim 1; and
controlling a robot on a basis of the information of the workpiece.

21. A product manufacturing method comprising:
obtaining information of a workpiece from captured image data obtained by imaging the workpiece, the information of the workpiece being obtained by using the leamed model obtained by the information processing method according to claim 1; and
controlling a robot on a basis of the information of the workpiece to manufacture a product.

22. An information processing apparatus comprising:
one or more processors configured to obtain a leamed model configured to output information of a workpiece,
wherein the one or more processors:
obtain first image data and second image data, the first image data including an image corresponding to a first number of workpieces disposed in a container or to the first number of virtual workpieces disposed in a virtual container, the second image data including an image corresponding to a second number of workpieces disposed in the container or to the second number of virtual workpieces disposed in the virtual container, the second number being different from the first number; and
obtain the leamed model by machine learning using the first image data and the second image data as input data.

23. An image processing apparatus comprising:
one or more processors configured to obtain a leamed model configured to output information of a workpiece,
wherein the one or more processors:
obtain first image data and second image data, the first image data including an image corresponding to a first number of workpieces disposed in a container or to the first number of virtual workpieces disposed in a virtual container, the second image data including an image corresponding to a second number of workpieces disposed in the container or to the second number of virtual workpieces disposed in the virtual container, the second number being different from the first number; and
obtain the leamed model by machine learning using the first image data and the second image data as input data.

24. A robot system comprising:
the information processing apparatus according to claim 22;
a robot; and
a controller configured to control the robot on a basis of the information of the workpiece.

25. A non-transitory computer-readable recording medium storing one or more programs including instructions for causing a computer to execute the information processing method according to claim 1.
